(19) United States
(12) Patent Application Publication
(10) Pub. No.: US 2014/0095322 A1
(43) Pub. Date: Apr. 3, 2014

(54) Advertising Management

(71) Applicants: Vinay Krishnaswamy, Woodinville, WA (US); Ravipal Soin, Kirkland, WA (US)

(72) Inventors: Vinay Krishnaswamy, Woodinville, WA (US); Ravipal Soin, Kirkland, WA (US)

(21) Appl. No.: 13/632,141

(22) Filed: Sep. 30, 2012

(51) Int. Cl. G06Q 30/02

(52) U.S. Cl. 705/14.69; 705/14.4

(57) ABSTRACT

Disclosed are, among other things, techniques to allow advertising management, providing a framework to share ad revenue between authors, publishers, hosts, or other stakeholders of content, and enforcing rules for advertisements.

### RELATED APPLICATIONS

This application claims priority to provisional application No. 61/525,156 filed Aug. 18, 2011 titled “Method and System for Collaborative Content Publishing and Consumption for Touch Sensitive Devices.”

### FIELD

This disclosure relates to Ad Revenue Sharing.

### BACKGROUND

The internet provides a foundation for people wishing to share pictures, text, multimedia, or other content with others. Quite often, the host of such content generates revenue by displaying ads on web sites.

### SUMMARY

The instant application discloses, among other things, techniques to allow Ad Revenue Sharing, providing a framework to share ad revenue between authors, publishers, hosts, or other stakeholders of content.

A content owner, publisher, or distributor may provide guidelines for the use of the content, providing rules pertaining to where the content may be published, where ads may be placed relative to the content display, dimensions of permissible ads, number of ads, types of ads, revenue allowable from ads, revenue sharing rules, formats of ads, or other criteria.

### BRIEF DESCRIPTION OF THE DRAWINGS

FIG. 1 is an example of a system on which Advertising Management may be implemented.

FIG. 2 illustrates several possible location restrictions for ad placements.

FIG. 3 illustrates a sample hierarchy which may be used to provide rules for Advertising Management.

FIG. 4 illustrates a sample hierarchy which may be used to provide revenue sharing rules with Advertising Management.

FIG. 5 illustrates a component diagram of a computing device according to one embodiment.

### DETAILED DESCRIPTION

A more particular description of certain embodiments of Advertising Management may be had by references to the embodiments shown in the drawings that form a part of this specification, in which like numerals represent like objects.

The instant application discloses, among other things, techniques to allow Advertising Management, and providing a framework to share advertising revenue between authors, publishers, hosts, or other stakeholders of content.

A content owner, publisher, or distributor may provide guidelines for the use of the content, providing rules pertaining to where the content may be published, where advertisements (ads) may be placed relative to the content display, dimensions of permissible ads, number of ads, types of ads, revenue allowable from ads, revenue sharing rules, formats of ads, or other criteria.

Advertisements may refer to static ads, multimedia ads, textual ads, graphical ads, video ads, or any other type of advertisement.

As an example, advertising revenue may be shared by a distributor, a publishing group, author, and reviewers. A distributor may get advertising revenue for providing content to a publishing group, such as an online magazine. The online magazine may get advertising revenue. The publishing group may have ad advertising revenue sharing model wherein authors or reviewers of content also get a share of advertising revenue.

Such advertising revenue sharing plans may be based on a number of impressions, a number of click-throughs, a number of completed purchases, referrals, or any other relevant metric. Sharing may be based on percentages, dollar values, cross-advertising space to run ads, or any other medium of exchange agreed upon by the interested parties.

One having skill in the art will recognize that many different ad formats and many different metrics are available for revenue generation from advertising.

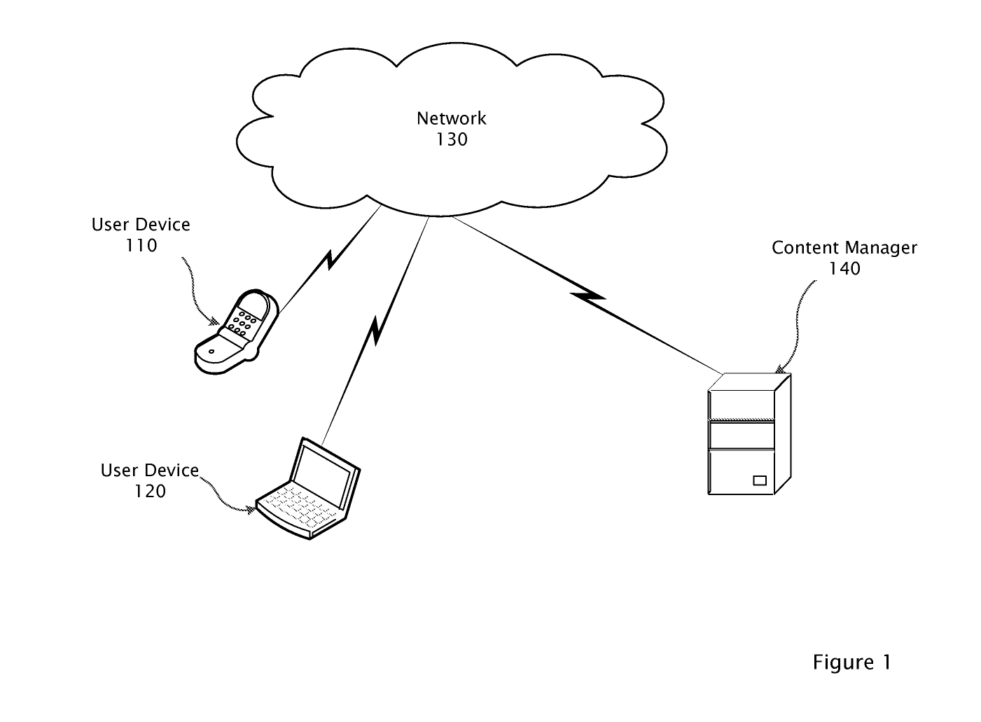

FIG. 1 is an example of a system on which Advertising Management may be implemented. User device 110, 120 may be used by a content owner or publisher to configure rules and guidelines for advertising. Content Manager 140 may store and enforce the rules and guidelines. User Devices 110, 120 may also be used to view content and ads made available from Content Manager 140. These functions may be performed through the use of a web site, through a dedicated application, or through other ways of accessing Content Manager 140.

User Devices 110, 120 may communicate with Content Manager 140 through Network 130. Network 130 may be a local area network, or it may include the Internet. Any type of communication link may be used, or all processing may occur on one device. Other types of data transfer may also be used, such as loading information from User Device 110 onto a portable drive and loading the information onto Content Manager 140.

Content Manager 140 may include one or more computers, and may serve a number of roles, including, but not limited to, storing and managing advertising rules and guidelines. For example, in one embodiment, Content Manager 140 may include a database with tables to store information about users, user devices, projects, articles, elements, layouts, layout definitions, advertising rules and guidelines, and other data that may be relevant for Advertising Management.

One skilled in the art will recognize that many User Devices 110, 120 may be used during Advertising Management, and that both User Devices 110, 120 and Content Manger 140 may be of different designs and capabilities.

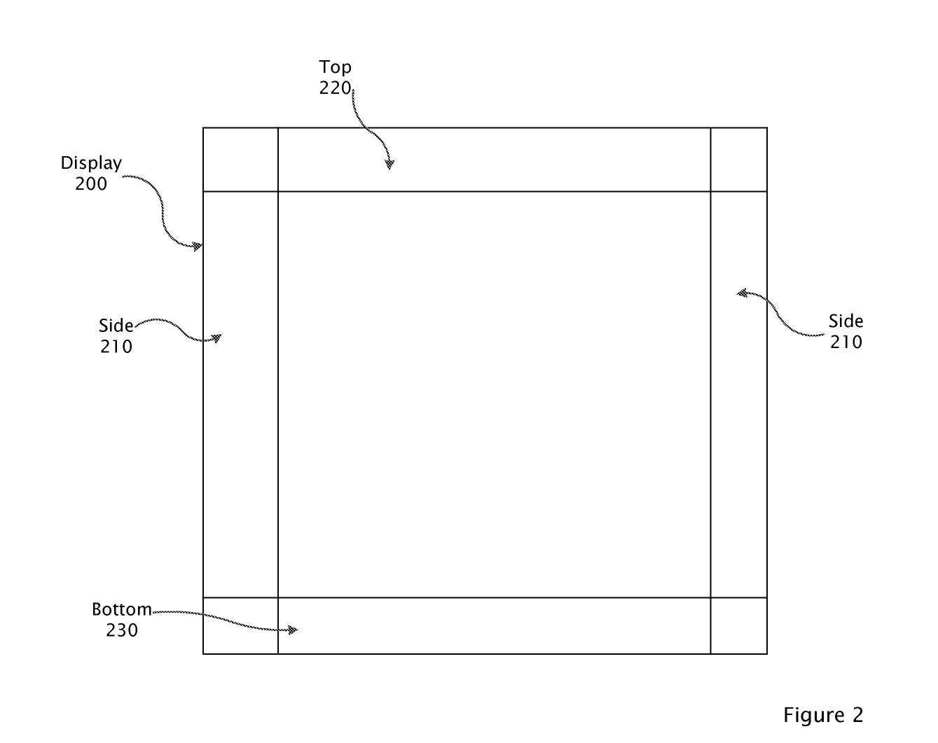

FIG. 2 illustrates several possible location restrictions for ad placements. Based on rules or guidelines, ads on Display 200 may be limited to Side 210, Top 220, or Bottom 230, or more specific positions such as top right or bottom right, or at the top or bottom of content. Other limitations on advertising may include, for example, size, ad content, format, revenue model, other ads being displayed, or source.

One having skill in the art will recognize that many types of restrictions may be placed on ads based upon rules or guidelines set out by various stakeholders.

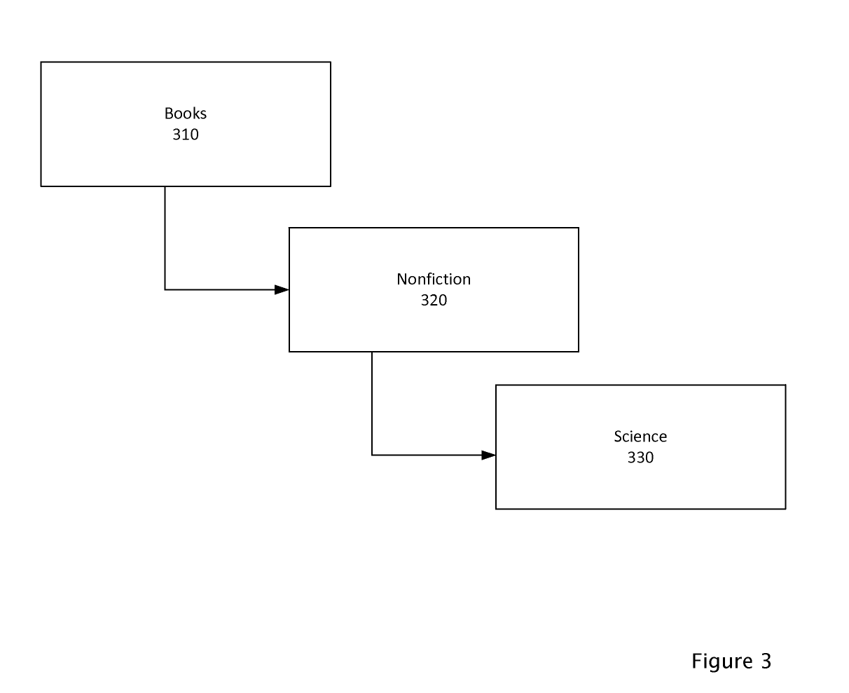

FIG. 3 illustrates a sample hierarchy which may be used to provide rules for Advertising Management. Advertisements placed on the Science leaf node 330 may be more restrictive than those placed on the Nonfiction node 320, which may be more restrictive than those placed on the Books root node 310. Hierarchies such as this may be used by implementing inheritance rules on advertisements, so that as the hierarchy is descended, each node has rules at least as restrictive as the level above it. In another embodiment, rules may apply to a depth of a level, but be independent of the rules of higher-level nodes.

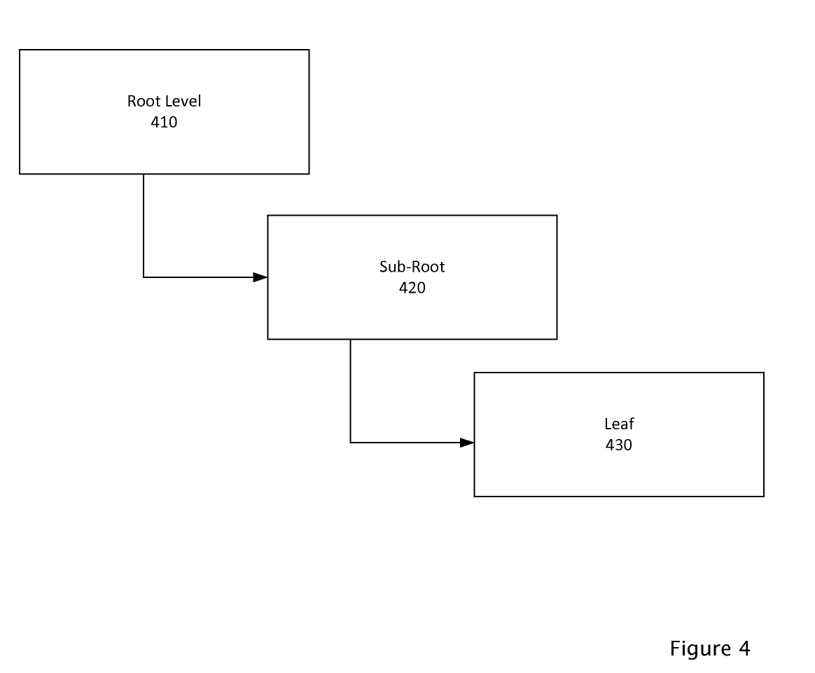

FIG. 4 illustrates a sample hierarchy which may be used to provide revenue sharing rules with Advertising Management. In this example, at Root Level 410 a portion of advertising revenue may be allocated for a content distributor. This portion may be inherited by any child nodes. At Sub-Root 420, a publishing group, for example an online magazine, may be allocated additional advertising revenue. At Leaf 430, which may have content published, advertising revenue for an author, reviewer, or other form of contributor may be allocated.

One having skill in the art will recognize that any number of levels may be implemented, and that inheritance of advertising revenue sharing rules from parent levels may be enforced and added to.

Advertising revenue allocation rules may have many forms. As examples and not limitations, they may include percentages, dollar values, cross-advertising space to run ads, or any other medium of exchange agreed upon by the interested parties. Rates may be fixed or variable, with, for example, an author receiving a higher percentage of advertising revenue if content is provided exclusively. Advertising revenue rates may also vary with location, site, time of day, volume of impressions, volume of click-throughs, or any other metric for valuing ads.

In one embodiment, advertising space may be sold using a bidding system. Bidding may be adjusted at the time a user is viewing content based on the specific user. For example, bids may be adjusted based on what the user reads, likes, searches for, services used, or other attributes of the user's profile. Specific attributes about a user may provide indicators of the likelihood of the user clicking on a particular type of ad, and a business may bid more for displaying an ad to the user if the user meets a particular demographic target.

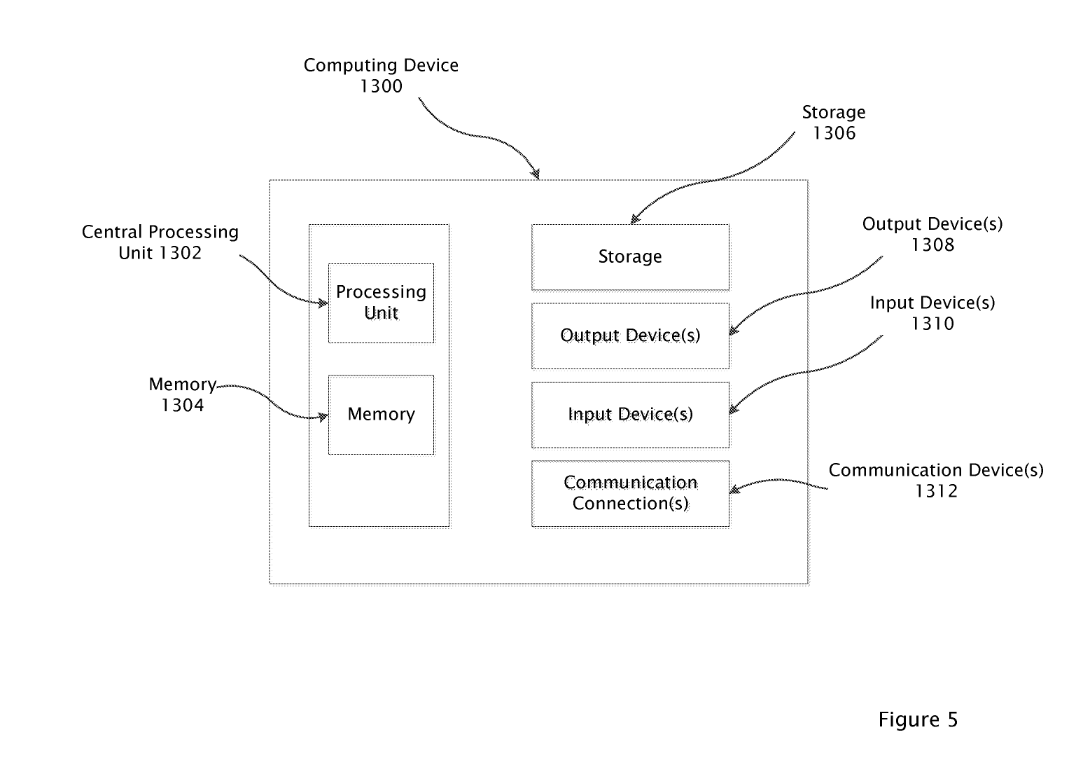

FIG. 5 illustrates a component diagram of a Computing Device according to one embodiment. The Computing Device (1300) can be utilized to implement one or more computing devices, computer processes, or software modules described herein, including, for example, but not limited to User Device 110, 120 or a Content Manager 140. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 120 or a Content Manager 140. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
an advertisement rule receiving component, configured to receive an advertising rule from a user device; and
an advertising rule enforcement component, configured to enforce advertising rules.

2. The system of claim 1, further comprising a user account management component, configured to allow creation, editing, and deletion of user accounts.

3. The system of claim 1 wherein the advertising rule comprises one or more rules based on criteria selected from a group comprising a viewing user, a user device, a project, articles, elements, layouts, and layout definitions.

4. The system of claim 1 further comprising an advertising rate determination component configured to determine a rate for an advertisement.

5. The system of claim 4 wherein the advertising rate determination is based on factors selected from the list comprising: location, site, time of day, volume of impressions, volume of click-throughs, and exclusivity of content.

6. The system of claim 4 wherein the advertising rate determination is based on a user's profile; the profile having one or more attributes selected from: types of articles the user reads, types of articles the user likes, the user's search history, and services the user has used.

7. A method, comprising:
determining a first rule for one or more attributes of an advertisement for a first level of a hierarchy of content displayed on a computer;
determining a second rule for one or more attributes of an advertisement for a second level of the hierarchy of content displayed on the computer; wherein the second rule inherits the first rule; and
enforcing the rules based on a level of hierarchy being displayed.

8. The method of claim 7 wherein the first rule is based on criteria selected from a group comprising a viewing user, a user device, a project, articles, elements, layouts, and layout definitions.

9. The method of claim 7 further comprising:
determining an advertising rate based on factors selected from the list comprising: location, site, time of day, volume of impressions, volume of click-throughs, and exclusivity of content.

10. The method of claim 7 further comprising:
determining an advertising rate based on a user's profile; the profile having one or more attributes selected from: types of articles the user reads, types of articles the user likes, the user's search history, and services the user has used.

11. A computer storage media containing instructions thereon which, when executed by a processor, execute a method comprising:
determining a first rule for one or more attributes of an advertisement for a first level of a hierarchy of content displayed on a computer;
determining a second rule for one or more attributes of an advertisement for a second level of the hierarchy of content displayed on the computer; wherein the second rule inherits the first rule; and
enforcing the rules based on a level of hierarchy being displayed.

12. The method of claim 11 wherein the first rule is based on criteria selected from a group comprising a viewing user, a user device, a project, articles, elements, layouts, and layout definitions.

13. The method of claim 11 further comprising:
determining an advertising rate based on factors selected from the list comprising: location, site, time of day, volume of impressions, volume of click-throughs, and exclusivity of content.

14. The method of claim 11 further comprising:
determining an advertising rate based on a viewing user's profile; the profile having one or more attributes selected from: types of articles the user reads, types of articles the user likes, the user's search history, and services the user has used.
